(19) United States
(12) Patent Application Publication
(10) Pub. No.: US 2018/0121465 A1
(43) Pub. Date: May 3, 2018

(54) NETWORK-BASED COMMUNICATION AND FILE SHARING SYSTEM

(71) Applicant: Microsoft Technology Licensing, LLC, Redmond, WA (US)

(72) Inventors: Sharad Bajaj, Redmond, WA (US); Kyle T. Blevens, Seattle, WA (US); Shruti Jain, Bellevue, WA (US)

(21) Appl. No.: 15/478,609

(22) Filed: Apr. 4, 2017

Related U.S. Application Data
(60) Provisional application No. 62/415,917, filed on Nov. 1, 2016.

(51) Int. Cl. G06F 17/30; H04L 29/08

(52) U.S. Cl. CPC G06F 17/30194; H04L 67/06

(57) ABSTRACT

A group file list cache is maintained for each of a plurality of different groups. An aggregate group file list is generated by accessing each group file list cache to obtain a list of files corresponding to each group that a user is associated with (or a subset of those groups). The list of files corresponding to each group is merged into a single, aggregate list and is surfaced for user interaction.

### BACKGROUND

Computing systems are currently in wide use. Some computing systems are file maintenance and sharing systems that allow a number of different users to access, share, and even collaborate on, files. Other computing systems include communication systems that allow users to communicate with one another using a communication mechanism, such as an on-line chat mechanism, telephone or video conferencing mechanisms, or a wide variety of other communication mechanisms. Some such communication systems also allow users to join groups such that communication can be simultaneously undertaken with a group of other individuals.

In such communication systems, files are often shared among group members. The files can often be worked on in a collaborative environment by the group members as well. The files may be stored in disparate locations for different groups, or they may be stored in disparate locations even within a single group.

A given user may also be members of multiple different groups (sometimes referred to as teams). Each group may have its own set of files being uploaded or edited on a daily basis. It can be difficult, time consuming and cumbersome to access files being worked on by each individual team. This makes keeping track of file activity for each group, individually, relatively laborious and time consuming.

The discussion above is merely provided for general background information and is not intended to be used as an aid in determining the scope of the claimed subject matter.

### SUMMARY

A group file list cache is maintained for each of a plurality of different groups. An aggregate group file list is generated by accessing each group file list cache to obtain a list of files corresponding to each group that a user is associated with (or a subset of those groups). The list of files corresponding to each group is merged into a single, aggregate list and is surfaced for user interaction.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a communication system architecture.

FIG. 2 is a flow diagram illustrating one example of the operation of the computing system architecture shown in FIG. 1 in generating an aggregate file list and surfacing it for user interaction.

FIGS. 3A and 3B show examples of user interfaces that can be generated for user interaction.

FIG. 4 is a block diagram showing one example of the architecture illustrated in FIG. 1, deployed in a cloud computing architecture.

FIGS. 5-7 show examples of mobile devices that can be used with the architectures illustrated in the previous figures.

FIG. 8 is a block diagram showing one example of a computing environment that can be used with the architectures shown in the previous figures.

### DETAILED DESCRIPTION

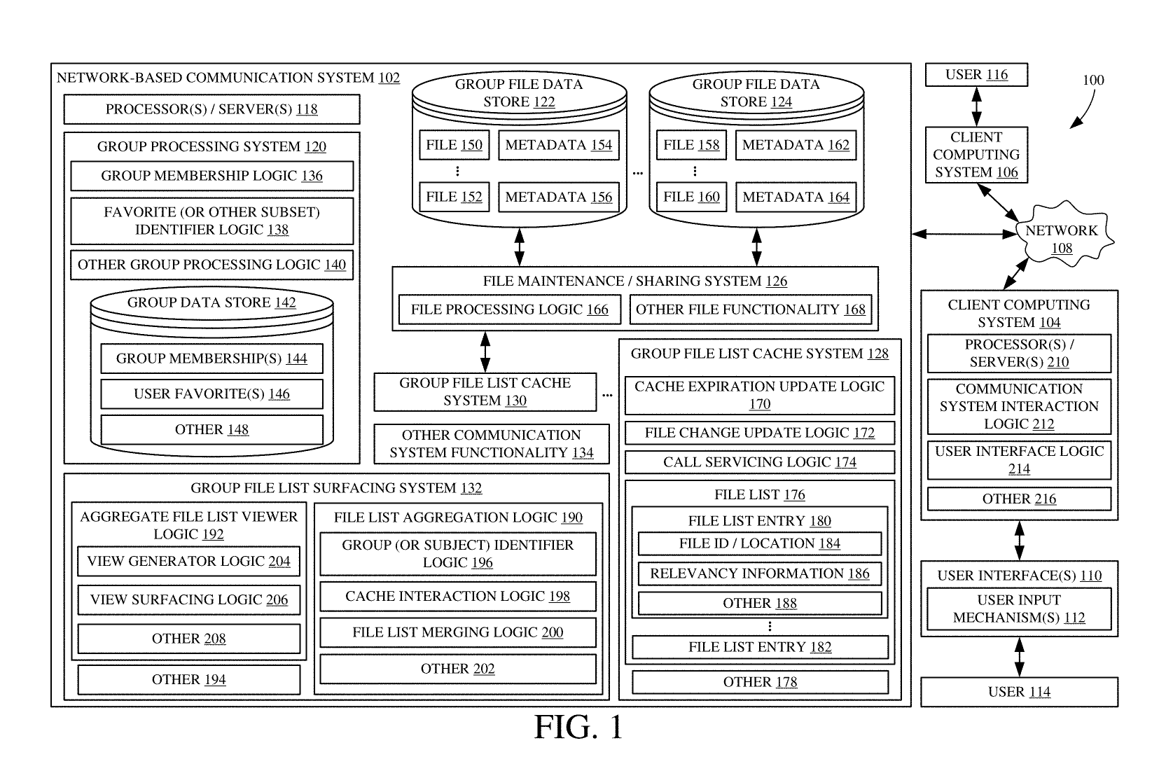

FIG. 1 is a block diagram of one example of a communication system architecture 100. Architecture 100 illustratively includes network-based communication system 102 that is coupled to a plurality of different client systems 104-106 through network 108. Network 108 can be any of a wide variety of different types of networks, such as a wide area network, a local area network, a near field communication network, a cellular network, or any of a wide variety of other networks or combinations of networks.

In the example shown in FIG. 1, client computing system 104 is shown generating user interfaces 110, with user input mechanisms 112, for interaction by user 114. It will be noted that computing system 106 can also generate user interfaces with user input mechanisms for interaction by user 116. However, those shown with respect to client computing system 104 are shown for the sake of example. User 114 illustratively interacts with user input mechanisms 112 on user interfaces 110 in order to control and manipulate client computing system 104 and some portions of network-based communication system 102.

In one example, users 114-116 can use network-based communication system 102 in order to communicate with one another. They can also illustratively belong to a plurality of different groups of users so that they can communicate with a group of users, and share and interact with documents within each group. Before describing the operation of architecture 100 in more detail, a brief discussion of some of the items in architecture 100, and their operation, will first be described.

Network-based communication system 102 illustratively includes one or more processors or servers 118, group processing system 120, group file data stores 122-124, file maintenance/sharing system 126, group file list cache systems 128-130, group file list surfacing system 132, and it can include a wide variety of other communication system functionality 134 as well. In the example shown in FIG. 1, group processing system 120 illustratively includes group membership logic 136, favorite (or other subset) identifier logic 138, other group processing logic 140, and group data store 142 (which can, itself, include group memberships 144, user favorites 146, and a wide variety of other items 148).

Each group file data store 122-124 illustratively includes a set of files 150-152 (with corresponding metadata 154-156), and files 158-160 (also with corresponding metadata 162-164), respectively. The files in each group file data store 122-124 are those files that correspond to the communication groups formed within network-based communication system 102. For instance, a particular group of users may share a set of files within the group, over a group communication interface (such as an on-line chat interface that supports group messages and file-sharing). They may collaborate on those files within the group, simply share access to the files, or share the files in other ways. In that case, each file shared or collaborated on within the group corresponds to that group. In the present example, each file corresponding to that group will be stored in a corresponding group file data store. It will be noted, however, that the files for a given group may be stored in multiple, disparate data stores as well. Some of those data stores may be local to network-based communication system 102, and some may be remote therefrom. All of these architectures are contemplated herein.

In one example, the metadata corresponding to each file illustratively identifies information about the file, such as its author, when it was created, when it was last edited, an edit history, and its location (such as the path name for navigating to the file). It can include a wide variety of other information as well.

File maintenance/sharing system 126 illustratively includes file processing logic 166 and other file functionality 168. File maintenance/sharing system 166 illustratively allows users 114-116 to access the files in the various group file data stores 122-124. It allows them to share files with other users or groups, and it also allows the user (who has appropriate access rights) to create, read, modify, delete, etc. those files. These types of functions are carried out by file processing logic 166.

Group processing system 120 illustratively generates interfaces that allow users 114-116 to set up and join groups of users. It illustratively allows users to create new groups, to name those groups, to add members to the groups, to participate in groups created by other users, etc. It thus includes group membership logic 136 which illustratively generates interfaces that allow users to perform these types of group membership tasks. Favorite identifier logic 138 illustratively allows a given user to identify his or her favorite groups, or to identify other subsets of groups.

The group memberships that are configured by the various users are illustratively stored as group memberships 144 in group data store 142. Group memberships 144 illustratively map various groups to the different sets of users of network-based communication system 102. This can be done using a group membership indicator that indicates which users are members of which groups, or in other ways. User favorites 146 illustratively identify the favorites or other subsets of groups corresponding to each user.

Currently, it is difficult for a user (such as user 114) to check on the activity of each of the groups that he or she belongs to, with respect to different files being shared or worked on by those groups. Currently, the user normally accesses each group separately, and attempts to view the various documents that have been recently accessed by members of those groups. This can be a time consuming and cumbersome process and takes multiple network calls because there is at least one call for each group the user is a member of, and there may even be more than one call per group. It can be very difficult for a user to track the recent activity of a group with respect to the files being shared or worked on by that group.

Therefore, in accordance with one example, network-based communication system 102 illustratively includes a set of group file list cache systems 128-130. Each system maintains a file list cache which has file list entries that identify the activity of the corresponding group on a particular file. In one example, each group file list cache system 128 includes cache expiration update logic 170, file change update logic 172, call servicing logic 174 and a cached file list 176. It can include other items 178 as well. Each cached file list 176 illustratively includes a set of file list entries 180-182. Each file list entry illustratively includes a file identifier and file location 184, a set of relevancy information (such as how recently the file was last updated, who it was updated by, etc.) 186, and it can include a wide variety of other information 188. Group file list cache system 130 can be similar to system 128, or different. For purposes of the present discussion, it is assumed that the two systems are similar so that only system 128 is described in more detail.

Cache expiration update logic 170 can determine that the cached file list is expired (such as in response to receiving a call for the cached file list) and interact with system 126 to update the cached file list for the corresponding group. File change update logic 172 can detect when files for the corresponding group have been changed, and can update the cached file list accordingly. Call servicing logic 174 can receive calls from group file list surfacing system 132 and interact with system 132 and other items in system 128, to service the call.

Group file list surfacing system 132 allows the user to access the cached file list 176 for each of the groups that user 114 belongs to (or for a subset of those groups, such as the groups that user 114 has identified as his or her favorites). System 132 thus illustratively includes file list aggregation logic 190, aggregate file list viewer logic 192, and it can include other items 194. File list aggregation logic 190 can include group (or subset) identifier logic 196, cache interaction logic 198, file list merging logic 200, and it can include other items 202. Aggregate file list viewer logic 192 illustratively includes view generator logic 204, view surfacing logic 206, and it can include other items 208.

File list aggregation logic 190 illustratively receives a call from client computing system 104 indicating that user 114 wishes to see recent activity on the files that are being shared or worked on by the groups that user 114 belongs to (or a subset of those groups—such as the groups user 114 has identified as being his or her favorites). Group (or a subset) identifier logic 196 then accesses group processing system 120 to identify which groups user 114 belongs to based on group memberships 142, and which groups he or she may have indicated are favorites (based on user favorites 146). Cache interaction logic 198 then interacts with group file list cache systems 128-130, corresponding to each of the identified groups (identified by logic 196), to obtain the cached file list 176 from each of those systems. File list merging logic 200 then merges each of the file lists into an aggregate list and provides it to aggregate file list viewer logic 192. View generator logic 204 generates a representation of the aggregate list that can be surfaced by view surfacing logic 206. In one example, the representation of the aggregate list is interactive in that it includes a user actuatable display element corresponding to each file in the list. For instance, the user can actuate the user actuatable display element to navigate to the corresponding document.

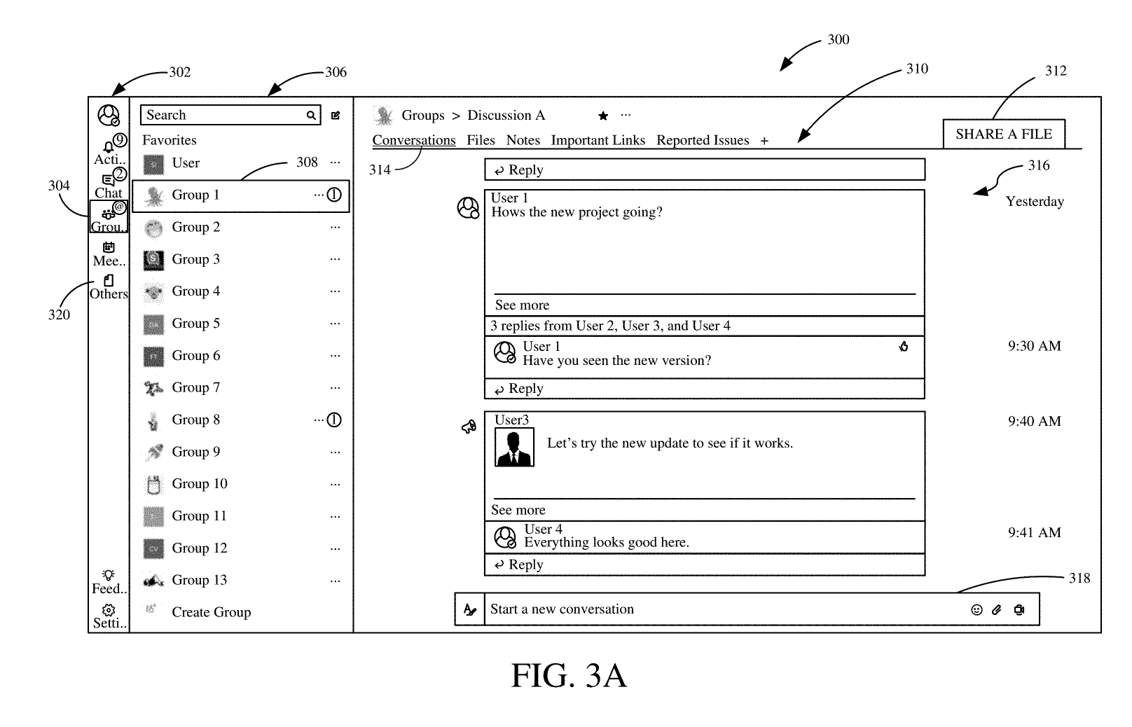

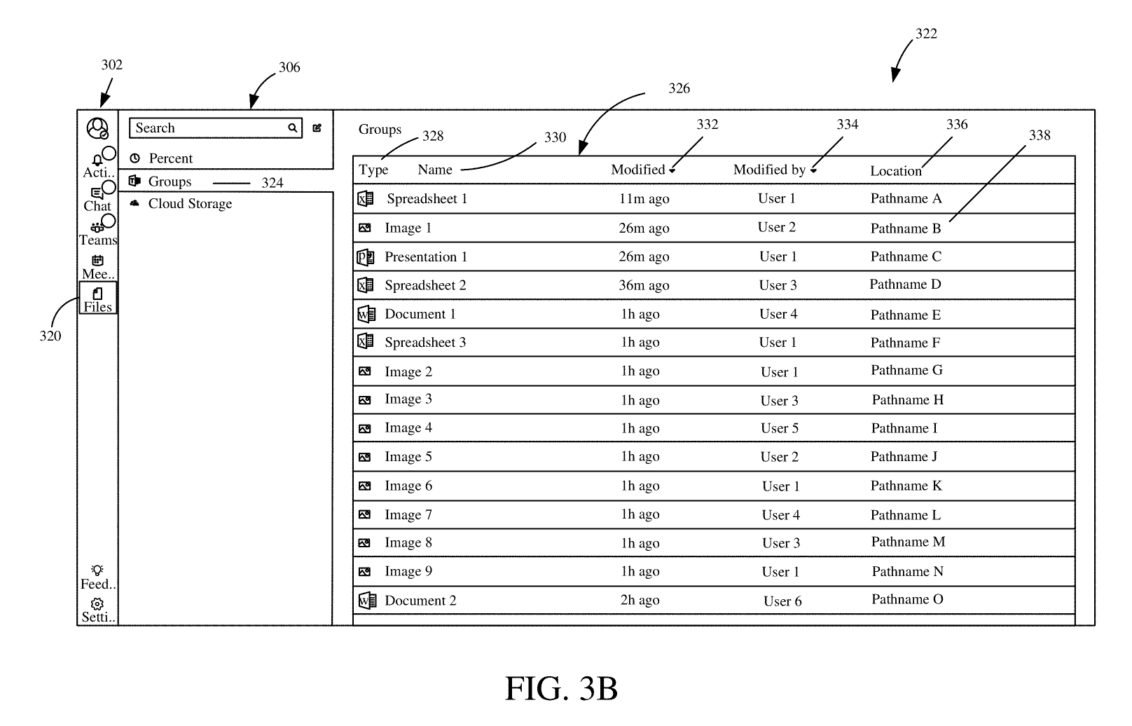

Client computing system 104, and client computing system 106 can be the same or different. For purposes of the present description, it will be assumed that they are the same so that only client computing system 104 is described in more detail. In one example, client computing system 104 can include one or more processors or servers 210, communication system interaction logic 212, user interface logic 214, and it can include one or more data stores or other items 216. Communication system interaction logic 212 illustratively interacts with network-based communication system 102. User interface logic 214, either by itself or under the control of another item, illustratively generates the user interfaces 110 and detects user interactions with user input mechanisms 112. Some examples of user interfaces are described in more detail below with respect to FIGS. 3A and 3B.

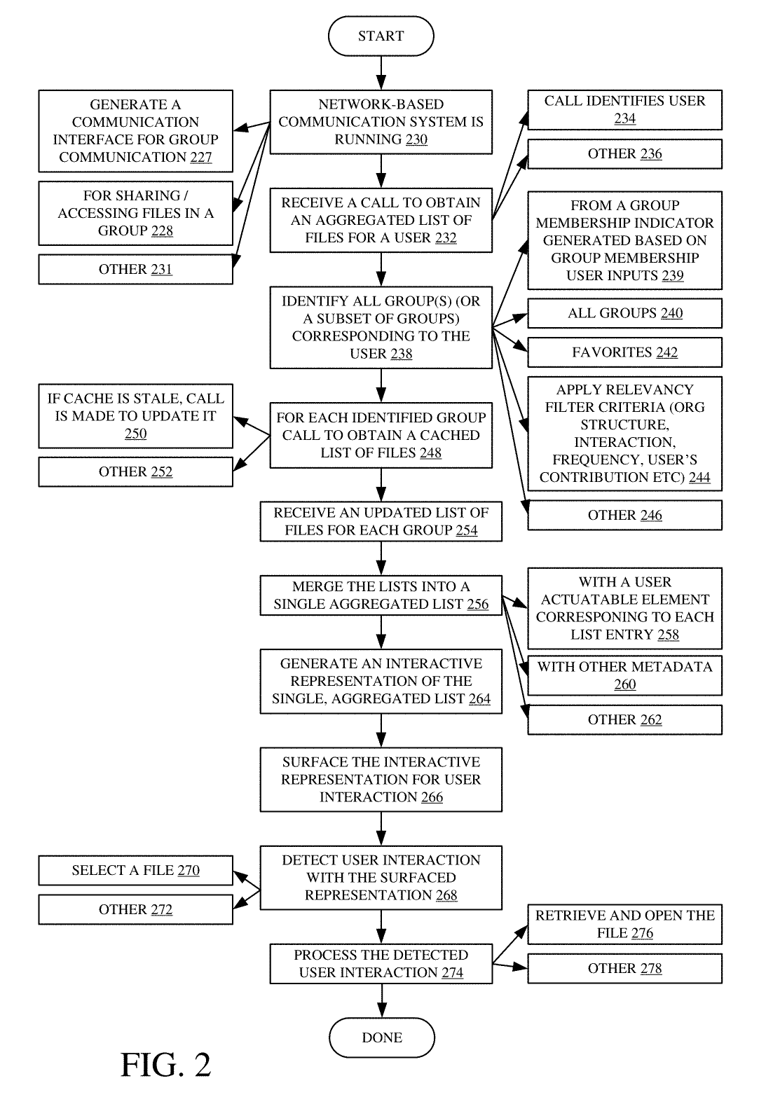

FIG. 2 is a flow diagram illustrating one example of the operation of the architecture 100 shown in FIG. 1, in receiving a call from a client computing system 104 and returning an interactive, aggregated group file list indicative of all recently used or accessed files by members of groups to which user 114 belongs (or optionally a subset of those groups, such as the user's favorites). It is first assumed that the network-based communication system 102 is running. This is indicated by block 230 in the flow diagram of FIG. 2. In doing so, it illustratively, generates a communication interface for group communication and for sharing and accessing files within groups. This is indicated by blocks 227 and 229. It can operate in a wide variety of other ways as well, as indicated by block 231.

Group file list surfacing system 132 then receives a call from client computing system 104 (such as through network 108) to obtain an aggregated list of files for user 114. This is indicated by block 232. In one example, the call identifies the user 114 using a user identifier that uniquely identifies the user to network-based communication system 102. This is indicated by block 234. The call can take other forms and identify the user in other ways as well, and this is indicated by block 236.

Group identifier logic 196 then identifies all groups (or a subset of those groups) corresponding to user 114. This is indicated by block 238 in the flow diagram of FIG. 2. In one example, logic 196 accesses group memberships 144 in group data store 142 to identify the various groups to which user 114 belongs. The memberships 144 can, for instance, include a group membership indicator that maps users to groups or groups to users, or identifies user membership in groups in other ways. This is indicated by block 239. Logic 196 can identify all groups of which user 114 is a member. This is indicated by block 240 in the flow diagram of FIG. 2. Also, in one example, logic 196 accesses user favorites 146 (or other criteria indicating other subsets of the groups) for user 114, and identifies the favorites or other subset. This is indicated by block 242 in the flow diagram of FIG. 2.

Group identifier logic 196 can also apply other relevancy filter criteria to identify a subset of the groups corresponding to user 114. For instance, logic 196 can access an organization structure corresponding to the tenant or organization to which user 114 belongs. Logic 196 can use that information to identify the groups corresponding to user 114. By way of example, it may be that the user's supervisor has recently been active on a set of groups, and those groups may be identified as groups corresponding to user 114. In another example, the relevancy filter criteria may be the frequency of interaction by user 114 on a particular group communication. For instance, if user 114 frequently communicates with, or performs actions in, a particular group, that group may be more relevant to user 114 than groups where user 114 very infrequently communicates or performs actions. Still other relevancy filter criteria may be a measure of the user's contribution to documents being accessed by a group. For example, if user 114 is the author of a number of documents currently being accessed by members of a group, that group may be more relevant than a group for which user 114 is not the author of any of the documents, or has not otherwise participated in editing or modifying documents. Applying other relevancy filter criteria is indicated by block 244 in the flow diagram of FIG. 2. Group identifier logic 196 can identify groups corresponding to user 114 in other ways as well, and this is indicated by block 246.

For each identified group, cache interaction logic 198 then calls the various group file list cache systems 128-130 (corresponding to the identified groups) to obtain a cached file list 176 for that group. This is indicated by block 248 in the flow diagram of FIG. 2. For instance, it can interact with call servicing logic 174 in group file list cache system 128 to obtain file list 176 for the corresponding group. If, upon receiving the call, call servicing logic 174 determines that the cache is stale (each cached file list may illustratively have an expiration time or date), then it invokes cache expiration update logic 170. Logic 170 interacts with file maintenance/sharing system 126 to update the cached file list 176 for the particular group. File maintenance/sharing system 126 then accesses the corresponding group file data store 122 (or multiple data stores if needed) to identify files that should be listed in the cached file list 176 (such as those most recently accessed in the corresponding group) and to update the cached file list 176. Making a call to update the cached file list 176, when it is stale, is indicated by block 250 in the flow diagram of FIG. 2. The call to each of the group file list cache systems 128-130 corresponding to the identified groups can be made in other ways as well, and this is indicated by block 252 in the flow diagram of FIG. 2.

Cache list interaction logic 198 then receives the updated, cached file list 176 from each group file list cache system 128-130 which it calls. Receiving the updated list of files for each group is indicated by block 254 in the flow diagram of FIG. 2.

The various lists are then provided to file list merging logic 200. Logic 200 merges the lists into a single, aggregated file list for user 214. This is indicated by block 256 in the flow diagram of FIG. 2. The lists can be merged in various ways, such as listing files in order of recency with which they were accessed, in order of relevance to the user 114, by group, etc. In one example, the aggregated list is interactive. For instance, it can include a user actuatable element corresponding to each file list entry. The user actuatable element may include a link to the underlying file identified by the file list entry. This is indicated by block 258 in the flow diagram of FIG. 2. Each list entry in the aggregated list can include other metadata as well, such as the author of the document, who last modified it, when it was last modified, the path name to the document, among a wide variety of other metadata. This is indicated by block 260. The list merging logic 200 can merge the various lists into a single, aggregated list in other ways as well. This is indicated by block 262.

Aggregate file list viewer logic 192 then generates an interactive representation that can be surfaced for user 114. View generator logic 204 first generates an interactive representation of the single, aggregated list, that was provided by list merging logic 200. Generating the interactive representation is indicated by block 264 in the flow diagram of FIG. 2.

View surfacing logic 206 then surfaces the interactive representation for user interaction. This is indicated by block 266. For instance, where the representation is to be displayed to the user, then view surfacing logic 206 surfaces the representation and provides it to client computing system 104 so that it can be displayed as a user interface 110 with the user actuatable elements being displayed as user input mechanisms 112. Where the user interface is an audio interface, then view surfacing logic 206 surfaces the representation to the client computing system 104 so that it can be presented to the user as an audio interface with the user input mechanisms 112 being actuated using voice commands. These and other interactive representations are contemplated herein.

At some point, it may be that user 114 interacts with the interactive representation that was surfaced. In that case, user interface logic 214 on client computing system 104 can detect that interaction and provide an indication of the interaction to network-based communication system 102 which can process the interaction. Detecting user interaction with the surfaced representation is indicated by block 268 in the flow diagram of FIG. 2. For instance, user 114 may select a file for being opened or otherwise viewed. Detecting file selection is indicated by block 270. In that case, view surfacing logic 206 will detect that the user has actuated one of the links or user input mechanisms in the surfaced, aggregated list (or receive an indicator indicating that the user interaction was detected) and provide that information to file maintenance/sharing system 126 which can open the file and provide access to it through the client computing system 104. It will of course be noted that the user can also interact with the surfaced representation in other ways as well, and this is indicated by block 272.

After the user interaction is detected, it is processed by client computing system 104 and/or network-based communication system 102. This is indicated by block 274. For instance, if the user selects a file for retrieval, opening or editing, the system can retrieve and open the file and present it to the user. This is indicated by block 276. The detected user interaction can be processed in a wide variety of other ways as well, based upon the user interaction, and this is indicated by block 278.

FIGS. 3A and 3B show examples of user interfaces that can be displayed in the architecture 100 shown in FIG. 1. FIG. 3A shows one example of a user interface display 300 that can be generated by communication system functionality 134 in network-based communication system 102. Display 300 illustratively includes a side panel 302 that has a plurality of different controls that can be actuated to see different views. In the example shown in FIG. 3A, panel 302 shows that a group actuator 304 has been actuated. Thus, pane 306 shows a plurality of groups to which user 114 belongs. In the example shown in FIG. 3A, each of the groups is represented by a user actuatable display element, and the display element 308 corresponding to “Group 1” has been actuated by the user. It can also be seen that the groups represented by the user actuatable display elements in pane 306 are divided into those that have been indicated as “favorites” by user 114, and other groups.

Display 300 also shows that, along a top portion of display 300, a set of controls 310 are displayed that allow user 114 to select conversations, files, notes, etc. In addition, a “Share a File” actuator 312 allows user 114 to share a file within a conversation. In the example shown in FIG. 3A, it can be seen that the user has actuated the conversations actuator 314. Thus, a set of conversations that have taken place in Group 1 are displayed in the conversations display pane 316. The user can reply to an existing conversation by actuating a reply actuator, or the user can start a new conversation by entering text into new conversation text box 318.

In order to view the aggregated list of files generated by group file list surfacing system 132, which will show a list of recently used files for the various groups that user 114 belongs to (in this case for the subset of groups that the user has labeled “favorites”), user 114 illustratively actuates the files actuator 320 in the side panel 302. In that case, group file list surfacing system 132 obtains the group file lists from each of the group file list cache systems 128-130 corresponding to the groups that the user has “favorited” and group file list surfacing system 132 aggregates the list, generates a representation of the list, and surfaces that representation, in this case as a displayed list. FIG. 3B shows one example of this.

FIG. 3B shows user interface display 322 that includes the side panel 302, showing that the user has selected the “files” actuator 320. In that case, pane 306 displays a set of user actuatable elements that can be actuated to see recent files, the aggregated file list for the user's groups (discussed above) or files that are stored on a cloud-based storage system. In the example shown in FIG. 3B, the user has actuated the groups user actuatable element 324. Therefore, the aggregate file list view is represented as a display and displayed as aggregate list 326 for the groups that have been favorited by user 114.

Each of the entries in the aggregate list 326 includes a file type indicator 328 indicating the type of file corresponding to the entry. It also includes a file name indicator 330 indicating the file name, a modified date indicator 332 indicating the last time that the file was modified, a modified by indicator 334 indicating who the file was last modified by, and a location indicator 336 indicating the current location of the most current version of the file.

In the example shown in FIG. 3B, the location is indicated by a user actuatable path name, such as path name 338 for the first entry in list 326. When the user actuates the path name 338, client computing system 104 and/or network-based communication system 102 opens the file, and allows the user to access the file (according to the user's permissions). In one example, the user is navigated to the location of the file, and in another example the file is retrieved and presented to the user for interaction according to his or her permissions.

It can thus be seen that the present description describes a system in which a list of files which have been accessed by members of groups to which a user belongs (or to which a user is otherwise related) can easily be obtained and aggregated into a single user interactive list and presented to the user. This can be done using a single network call to network-based communication system 102. This significantly enhances the operation of the computing system itself, because the list of files can be obtained with a single network call, instead of the user needing to navigate to different groups that the user belongs to, then somehow obtain a list of files from each group, and then somehow aggregate the list themselves or using another tool. This reduces the bandwidth and computing overhead needed to obtain such a list, thus improving the operation of the computing system. It also greatly reduces the work needed on behalf of the user, thus enhancing the user experience as well.

The present discussion has mentioned processors and servers. In one example, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

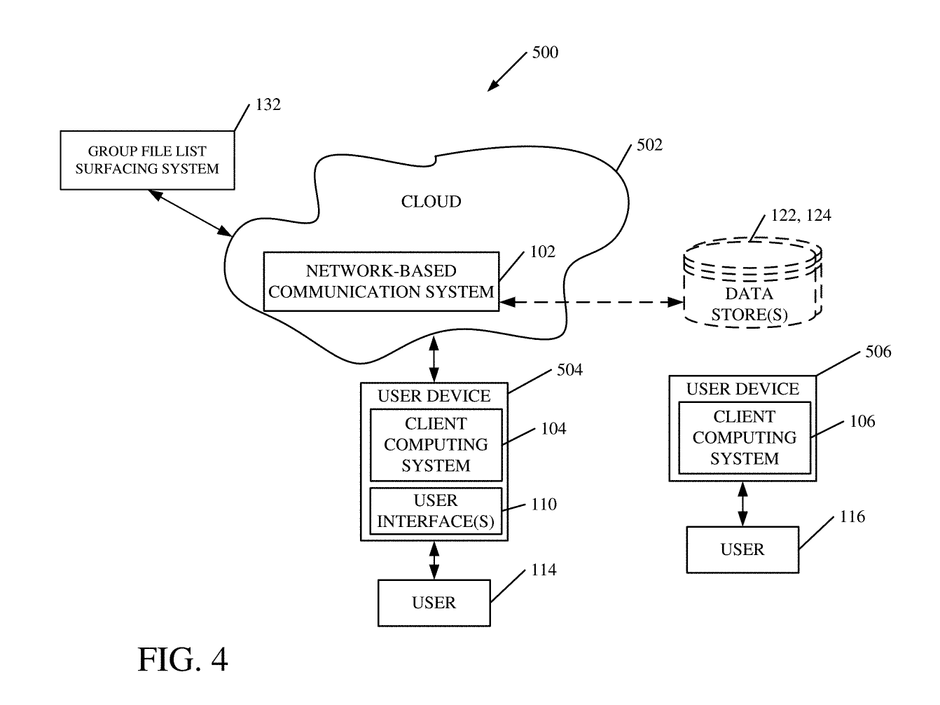

FIG. 4 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 4, some items are similar to those shown in FIG. 1 and they are similarly numbered. FIG. 4 specifically shows that network-based communication system 102 can be located in cloud 502 (which can be public, private, or a combination where portions are public while others are private). Therefore, users 114-116 use user devices 504-506 to access those systems through cloud 502.

FIG. 4 also depicts another example of a cloud architecture. FIG. 4 shows that it is also contemplated that some elements of system 102 can be disposed in cloud 502 while others are not. By way of example, data stores 122-124 (or others) can be disposed outside of cloud 502, and accessed through cloud 502. In another example, group file list surfacing system 132 (or other items) can also be outside of cloud 502. Regardless of where they are located, they can be accessed directly by devices 504-506, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

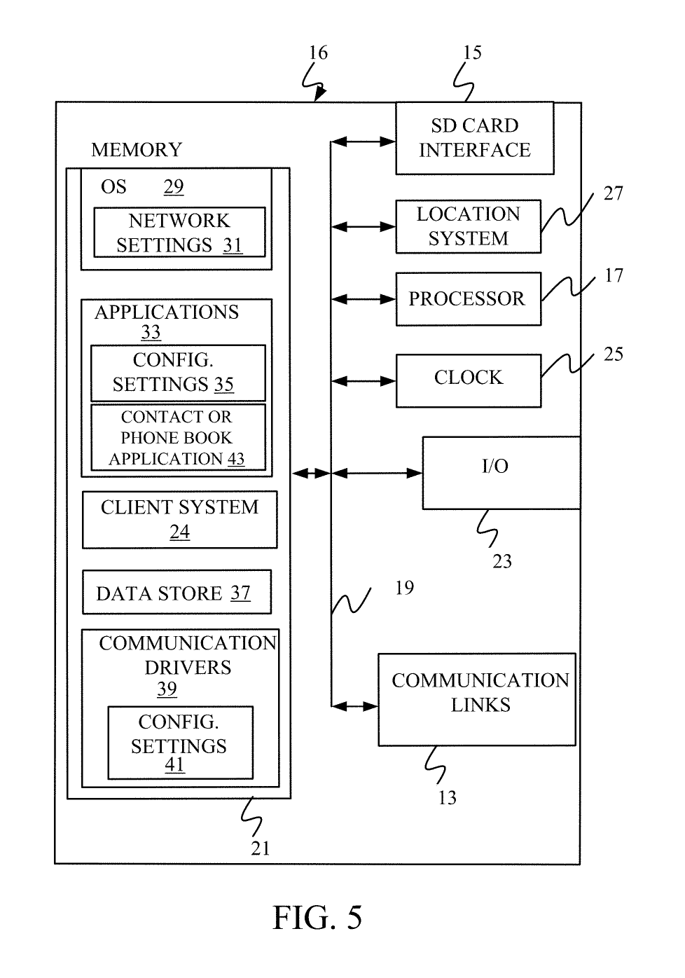

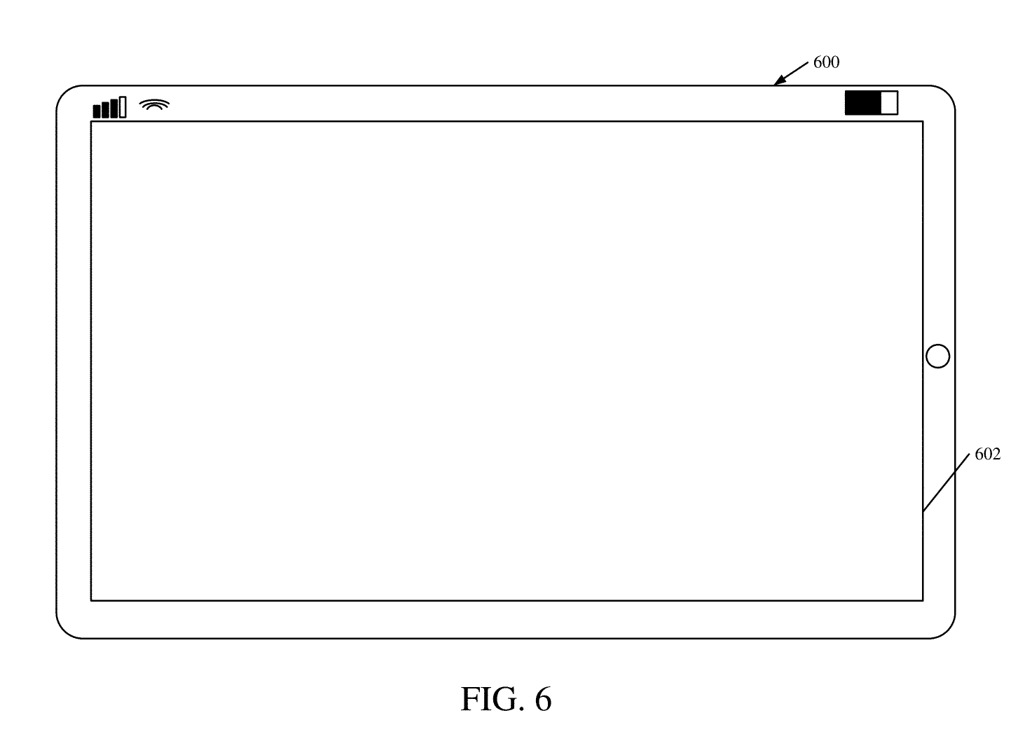

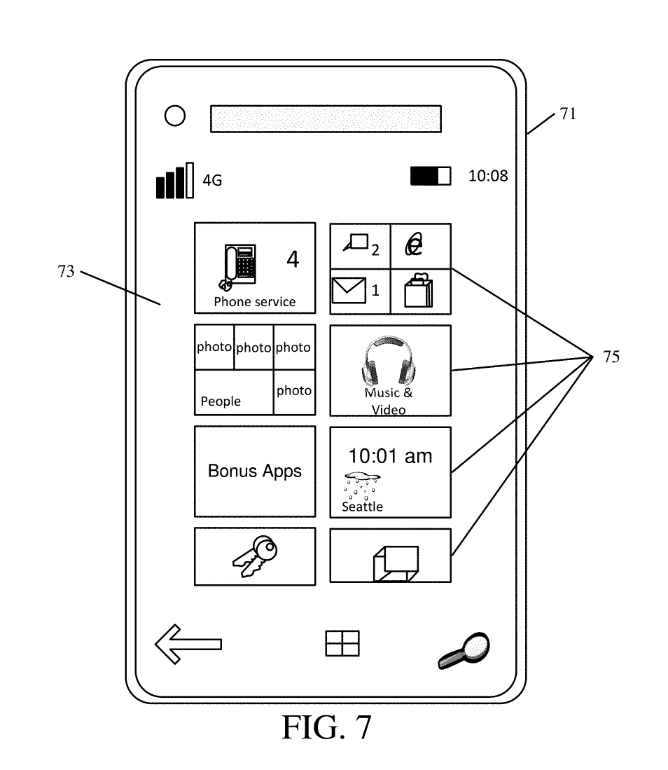

FIG. 5 is a simplified block diagram of one illustrative example of a handheld or mobile computing device that can be used as a user's or client's hand held device 16, in which the present system (or parts of it) can be deployed. FIGS. 6-7 are examples of handheld or mobile devices.

FIG. 5 provides a general block diagram of the components of a client device 16 that can run components of system 102 or that interacts with system 102, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers from previous FIGS.) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of systems 102, 104, 106. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one example in which device 16 is a tablet computer 600. In FIG. 6, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 7 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

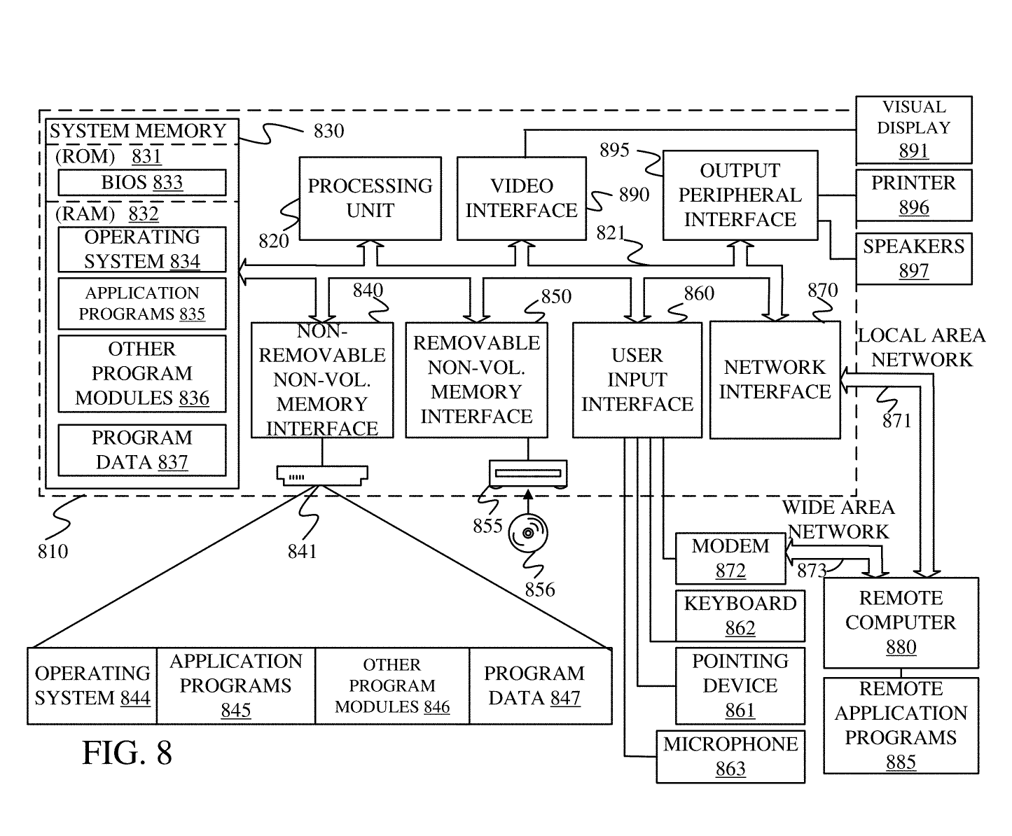

FIG. 8 is one example of a computing environment in which architecture 100, or parts of it, (for example) can be deployed. With reference to FIG. 8, an example system for implementing some embodiments includes a general-purpose computing device in the form of a computer 810. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 8.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable volatile/nonvolatile computer storage media. By way of example only, FIG. 8 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

group membership logic that receives group membership user inputs from a user and generates a group membership indicator indicating a plurality of groups that the user is a member of, based on the group membership user inputs, each group having a plurality of members;

a communication system having communication functionality that generates a group communication interface that receives a group message from the user, for a given group, and sends the group message to other members of the given group, the members of the plurality of groups accessing files through the group communication interface; and

a group file list surfacing system that identifies the files accessed by members of the plurality of groups through the group communication interface and generates a user-interactive list of the identified files for surfacing to the user.

Example 2 is the computing system of any or all previous examples, wherein the group file list surfacing logic comprises:

group identifier logic configured to receive a file request indicative of a file request user input from the user, and identify, as an identified group, the user and the plurality of groups of which the user is a member.

Example 3 is the computing system of any or all previous examples, wherein the group file list surfacing logic comprises:

cache interaction logic configured to obtain, from a file list cache system corresponding to each identified group, a file list that has a file entry for each file, in a set of files, accessed by the corresponding group.

Example 4 is the computing system of any or all previous examples, wherein the group file list surfacing logic comprises:

file list merging logic configured to combine the file lists from each of the file list cache systems, to generate an aggregate file list.

Example 5 is the computing system of any or all previous examples, wherein the group file list surfacing system comprises:

aggregate file list viewer logic configured to generate a representation of the aggregate file list, with a user actuatable element corresponding to each file entry on the aggregate list, as the user-interactive list.

Example 6 is the computing system of any or all previous examples, wherein the aggregate file list viewer logic is configured to generate the user actuatable elements, corresponding to the file entries, as links to the corresponding files.

Example 7 is the computing system of any or all previous examples, wherein the computing system further comprises the file list cache systems, one file list cache system corresponding to each of the plurality of groups, each file list cache system being configured to generate the file list as a cached list of files interacted with by at least one member of the corresponding group.

Example 8 is the computing system of any or all previous examples, wherein each file list cache system comprises:

cache expiration update logic configured to determine whether the cached list of files for the corresponding group has expired and, if so, update the cached file list by identifying a set of most recently accessed files, from at least a first data store, that were interacted with by at least one member of the corresponding group.

Example 9 is the computing system of any or all previous examples, wherein at least one file list cache system is configured to generate the corresponding cached list of files from files in a first data store and at least a second file list cache system is configured to generate the corresponding cached file list of files from files in a second data store that is that is separate and remote from the first data store.

Example 10 is the computing system of any or all previous examples, wherein each file list cache system comprises:

file change update logic configured to detect a change to a file by a member of the corresponding group and to update the cached file list by adding a file entry for the changed file in a set of most recently accessed files, from at least a first data store, that were interacted with by at least one member of the corresponding group.

Example 11 is a computer implemented method, comprising:

receiving group membership user inputs from a user;

generating a group membership indicator indicating a plurality of groups that the user is a member of, based on the group membership user inputs, each group having a plurality of members;

generating a group communication interface that receives a group message from the user, for a given group, and sends the group message to other members of the given group, the members of the plurality of groups accessing files through the group communication interface;

identifying the files accessed by members of the plurality of groups through the group communication interface; and

generating a user-interactive list of the identified files for surfacing to the user.

Example 12 is the computer implemented method of any or all previous examples, wherein generating a user-interactive list comprises:

receiving a file request indicative of a file request user input from the user; and

identifying, as an identified group, the user and the plurality of groups of which the user is a member.

Example 13 is the computer implemented method of any or all previous examples, wherein generating the user-interactive list comprises:

obtaining, from a file list cache system corresponding to each identified group, a file list that has a file entry for each file, in a set of files, accessed by the corresponding group.

Example 14 is the computer implemented method of any or all previous examples, wherein generating the user-interactive list comprises:

combining the file lists from each of the file list cache systems, to generate an aggregate file list; and

generating a representation of the aggregate file list, with a user actuatable element corresponding to each file entry on the aggregate list, as the user-interactive list.

Example 15 is the computer implemented method of any or all previous examples, wherein generating a representation of the aggregate list comprises:

generating the user actuatable elements, corresponding to the file entries, as links to the corresponding files.

Example 16 is the computer implemented method of any or all previous examples, wherein one file list cache system corresponds to each of the plurality of groups, and wherein obtaining the file list from each file list cache system comprises:

generating, at the file list cache system, the file list as a cached list of files interacted with by at least one member of the corresponding group.

Example 17 is the computer implemented method of any or all previous examples, wherein generating the file list comprises:

determining whether the cached list of files for the corresponding group has expired; and

if so, updating the cached file list by identifying a set of most recently accessed files, from at least a first data store, that were interacted with by at least one member of the corresponding group.

Example 18 is the computer implemented method of any or all previous examples, wherein generating the cached list of files comprises:

generating, with at least one file list cache system, the corresponding cached list of files from files in a first data store; and

generating, with at least a second file list cache system, the corresponding cached list of files from files in a second data store that is that is separate and remote from the first data store.

Example 19 is the computer implemented method of any or all previous examples, wherein generating the file list comprises:

detecting a change to a file by a member of the corresponding group; and

updating the cached file list by adding a file entry for the changed file in a set of most recently accessed files, from at least a first data store, that were interacted with by at least one member of the corresponding group.

Example 20 is a computing system, comprising:

group membership logic that receives group membership user inputs from a user and generates a group membership indicator indicating a plurality of groups that the user is a member of, based on the group membership user inputs, each group having a plurality of members;

a communication system having communication functionality that generates a group communication interface that receives a group message from the user, for a given group, and sends the group message to other members of the given group, the members of the plurality of groups accessing files through the group communication interface, at least two of the files being stored in separate data stores from one another, the separate data stores being remote from one another;

group identifier logic configured to receive a file request indicative of a file request user input from the user, and identify, as an identified group, the user and the plurality of groups of which the user is a member;

cache interaction logic configured to obtain, from a file list cache system corresponding to each identified group, a file list that has a file entry for each file, in a set of files, accessed by the corresponding group;

file list merging logic configured to combine the file lists from each of the file list cache systems, to generate an aggregate file list; and

a group file list surfacing system that generates a user-interactive list of the identified files, in the aggregate file list, for surfacing to the user.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
group membership logic that receives group membership user inputs from a user and generates a group membership indicator indicating a plurality of groups that the user is a member of, based on the group membership user inputs, each group having a plurality of members;
a communication system having communication functionality that generates a group communication interface that receives a group message from the user, for a given group, and sends the group message to other members of the given group, the members of the plurality of groups accessing files through the group communication interface; and
a group file list surfacing system that identifies the files accessed by members of the plurality of groups through the group communication interface and generates a user-interactive list of the identified files for surfacing to the user.

2. The computing system of claim 1 wherein the group file list surfacing logic comprises:
group identifier logic configured to receive a file request indicative of a file request user input from the user, and identify, as an identified group, the user and the plurality of groups of which the user is a member.

3. The computing system of claim 2 wherein the group file list surfacing logic comprises:
cache interaction logic configured to obtain, from a file list cache system corresponding to each identified group, a file list that has a file entry for each file, in a set of files, accessed by the corresponding group.

4. The computing system of claim 3 wherein the group file list surfacing logic comprises:
file list merging logic configured to combine the file lists from each of the file list cache systems, to generate an aggregate file list.

5. The computing system of claim 4 wherein the group file list surfacing system comprises:
aggregate file list viewer logic configured to generate a representation of the aggregate file list, with a user actuatable element corresponding to each file entry on the aggregate list, as the user-interactive list.

6. The computing system of claim 5 wherein the aggregate file list viewer logic is configured to generate the user actuatable elements, corresponding to the file entries, as links to the corresponding files.

7. The computing system of claim 5 wherein the computing system further comprises the file list cache systems, one file list cache system corresponding to each of the plurality of groups, each file list cache system being configured to generate the file list as a cached list of files interacted with by at least one member of the corresponding group.

8. The computing system of claim 7 wherein each file list cache system comprises:
cache expiration update logic configured to determine whether the cached list of files for the corresponding group has expired and, if so, update the cached file list by identifying a set of most recently accessed files, from at least a first data store, that were interacted with by at least one member of the corresponding group.

9. The computing system of claim 8 wherein at least one file list cache system is configured to generate the corresponding cached list of files from files in a first data store and at least a second file list cache system is configured to generate the corresponding cached file list of files from files in a second data store that is that is separate and remote from the first data store.

10. The computing system of claim 7 wherein each file list cache system comprises:
file change update logic configured to detect a change to a file by a member of the corresponding group and to update the cached file list by adding a file entry for the changed file in a set of most recently accessed files, from at least a first data store, that were interacted with by at least one member of the corresponding group.

11. A computer implemented method, comprising:
receiving group membership user inputs from a user;
generating a group membership indicator indicating a plurality of groups that the user is a member of, based on the group membership user inputs, each group having a plurality of members;
generating a group communication interface that receives a group message from the user, for a given group, and sends the group message to other members of the given group, the members of the plurality of groups accessing files through the group communication interface;
identifying the files accessed by members of the plurality of groups through the group communication interface; and
generating a user-interactive list of the identified files for surfacing to the user.

12. The computer implemented method of claim 11 wherein generating a user-interactive list comprises:
receiving a file request indicative of a file request user input from the user; and
identifying, as an identified group, the user and the plurality of groups of which the user is a member.

13. The computer implemented method of claim 12 wherein generating the user-interactive list comprises:
obtaining, from a file list cache system corresponding to each identified group, a file list that has a file entry for each file, in a set of files, accessed by the corresponding group.

14. The computer implemented method of claim 13 wherein generating the user-interactive list comprises:
combining the file lists from each of the file list cache systems, to generate an aggregate file list; and
generating a representation of the aggregate file list, with a user actuatable element corresponding to each file entry on the aggregate list, as the user-interactive list.

15. The computer implemented method of claim 14 wherein generating a representation of the aggregate list comprises:
generating the user actuatable elements, corresponding to the file entries, as links to the corresponding files.

16. The computer implemented method of claim 14 wherein one file list cache system corresponds to each of the plurality of groups, and wherein obtaining the file list from each file list cache system comprises:
generating, at the file list cache system, the file list as a cached list of files interacted with by at least one member of the corresponding group.

17. The computer implemented method of claim 16 wherein generating the file list comprises:
determining whether the cached list of files for the corresponding group has expired; and
if so, updating the cached file list by identifying a set of most recently accessed files, from at least a first data store, that were interacted with by at least one member of the corresponding group.

18. The computer implemented method of claim 16 wherein generating the cached list of files comprises:
generating, with at least one file list cache system, the corresponding cached list of files from files in a first data store; and
generating, with at least a second file list cache system, the corresponding cached list of files from files in a second data store that is that is separate and remote from the first data store.

19. The computer implemented method of claim 16 wherein generating the file list comprises:
detecting a change to a file by a member of the corresponding group; and
updating the cached file list by adding a file entry for the changed file in a set of most recently accessed files, from at least a first data store, that were interacted with by at least one member of the corresponding group.

20. A computing system, comprising:
group membership logic that receives group membership user inputs from a user and generates a group membership indicator indicating a plurality of groups that the user is a member of, based on the group membership user inputs, each group having a plurality of members;
a communication system having communication functionality that generates a group communication interface that receives a group message from the user, for a given group, and sends the group message to other members of the given group, the members of the plurality of groups accessing files through the group communication interface, at least two of the files being stored in separate data stores from one another, the separate data stores being remote from one another;
group identifier logic configured to receive a file request indicative of a file request user input from the user, and identify, as an identified group, the user and the plurality of groups of which the user is a member;
cache interaction logic configured to obtain, from a file list cache system corresponding to each identified group, a file list that has a file entry for each file, in a set of files, accessed by the corresponding group;
file list merging logic configured to combine the file lists from each of the file list cache systems, to generate an aggregate file list; and
a group file list surfacing system that generates a user-interactive list of the identified files, in the aggregate file list, for surfacing to the user.
